(19) United States
(12) Patent Application Publication
(10) Pub. No.: US 2018/0223490 A1
(43) Pub. Date: Aug. 9, 2018

(54) Portable Blower

(71) Applicants: Freddie Garcia, Chicago, IL (US); Sabrina Garcia, Chicago, IL (US); Freeda Garcia, Chicago, IL (US)

(72) Inventors: Freddie Garcia, Chicago, IL (US); Sabrina Garcia, Chicago, IL (US); Freeda Garcia, Chicago, IL (US)

(21) Appl. No.: 15/890,911

(22) Filed: Feb. 7, 2018

Related U.S. Application Data
(60) Provisional application No. 62/456,683, filed on Feb. 9, 2017.

(51) Int. Cl. E01H 5/10; F24H 3/04; A01G 20/47

(52) U.S. Cl. CPC E01H 5/102; A01G 20/47; F24H 3/0423

(57) ABSTRACT

Hand held and sling-supported portable and rechargeable electric or gas-powered blowers capable of delivering hot air via a high-speed fan and molded nozzle for removing leaves, debris, and eliminating snow and ice on driveways, walkways, steps, and vehicles.

### CLAIM OF PRIORITY

This patent application claims priority under 35 USC 119 (e) (1) from U.S. Provisional Patent Application Ser. No. 62/456,683 filed Feb. 9, 2017, of Freddie Garcia entitled, “Snow Blower,” which is incorporated herein by reference as though the same were set forth in its entirety.

### FIELD OF THE INVENTION

The present invention pertains to the field of blowers, including snow blowers and more specifically to the field of snow blowers providing hand held and sling-supported electric and gas-powered snow blowers delivering hot air via a high-speed fan and molded nozzle.

### BACKGROUND OF THE INVENTION

Millions of people in the nation's colder regions, winter, after the first couple of major snowstorms, is less a Christmas-card scene of silent, snow swept serenity than a constant and bitter battle with the elements. Snow may blanket the landscape in virginal white, but in order for you to get in or out of your house, or go anywhere, you have to plow, shovel, blow, or throw that snow. When winter comes to the North and the West, thousands of heavy-duty, industrial-grade snowplows are put into action with every significant snowfall. But while the big plows keep the roads cleared, consumers are left to their own devices when it comes to their sidewalks, porches and steps, and when clearing a path to their cars. For millions of people, this is the job for the snow shovel, lifting and throwing snow, often in the dark hours of early evening or morning. Even with a snow-thrower or snow-blower, the snow is simply moved from one place to another.

The prior art has put forth several designs for snow blowers. Among these are:

U.S. Pat. No. 4,366,368 to William S. Stephens III describes a portable frost and snow removing appliance for use in removing ice and snow from the surfaces of vehicle windows includes an elongated housing having a pistol handgrip at one end and containing an electrically operated two-speed blower and a resistance heater arranged to produce a high speed jet of unheated air or a slower stream of heated air through a discharge nozzle shiftably mounted on the other end of the housing and movable between first and second positions. The housing includes a lateral air outlet in a side wall between the heater and nozzle. The nozzle includes as a unitary one-piece structure therewith valve members within the housing and nozzle and cooperatively associated with the housing other end and the lateral air outlet to inversely open and close the lateral outlet and housing other end in response to shifting of the nozzle to its first and second positions, respectively, to permit air to be selectively discharged from either the nozzle or lateral air outlet. The housing is capable of being placed on its side upon the upper surface of a vehicle dash and operated in a manner to discharge heated air through the lateral air outlet upwardly along the inner windshield surface.

US Patent Application No. 2009/0307936 to Kent O. Rolsten describes an apparatus for removal of at least one of snow and ice from a surface includes a housing having a predetermined shape, at least one intake port and a discharge port and a handle engageable with the housing for carrying and operating the apparatus. A heating member is mounted adjacent the discharge port and a powered blower is disposed within the housing for drawing air through the at least one intake port and exhausting the air through at least a portion of the heating means and through the discharge port, whereby the exhausted air is heated by the heating means. A nozzle is engageable with the housing adjacent the discharge port for applying the exhausted heated air under pressure onto the at least one of snow and ice and a control switch is provided for selectively activating and deactivating the powered blower.

US Patent Application No. 2012/0093490 to Joel Steinberg describes an ice melting device comprising a body section comprising at least one blower and a heater. The blower heater comprises at least one heating coil and at least one shield forming a thermal shield for the heater. There is at least one nozzle for directing air produced by the blower, wherein the heater is positioned downstream of the blower so that fluid flow produced by the blower passes the heater and is heated by the heater and is then passed through the nozzle so that the hot air melts ice on a surface.

None of these prior art references describe the present invention.

### SUMMARY OF THE INVENTION

It is an object of the present invention to provide hand held and sling-supported electric or gas-powered blowers capable of delivering hot air via a high-speed fan and molded nozzle.

It is a further object of the present invention to provide

### BRIEF DESCRIPTION OF THE DRAWINGS

FIG. 1 is a perspective view illustrating a portable blower, constructed in accordance with the present invention, with a handle grip.

FIG. 2 is a perspective view illustrating a rechargeable blower, constructed in accordance with the present invention, with an over the shoulder strap.

### DETAILED DESCRIPTION OF THE INVENTION

Please refer to the drawings.

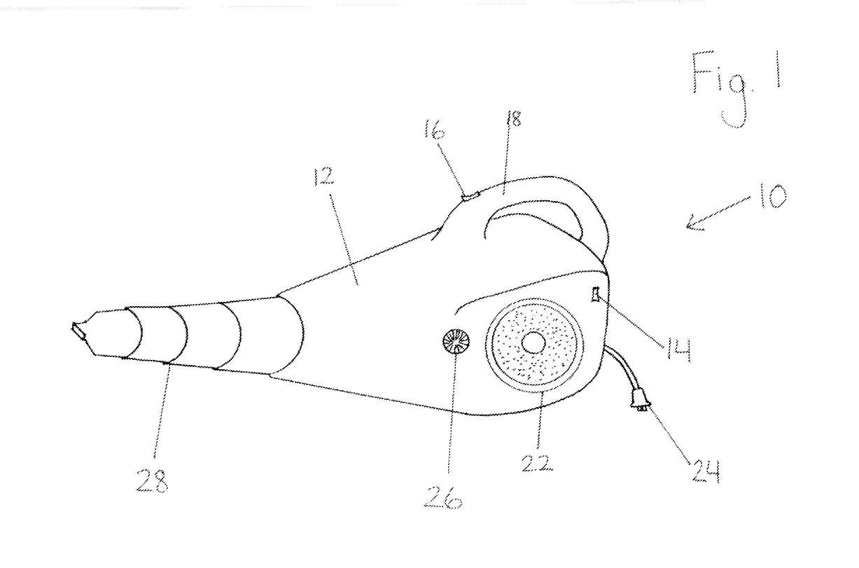

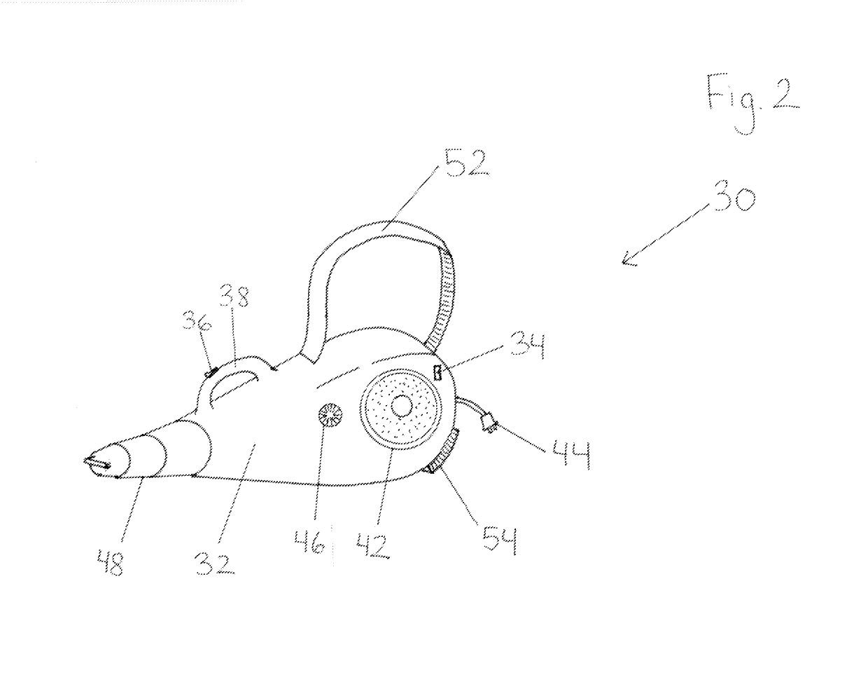

As illustrated in FIGS. 1 and 2, the present invention, Portable Blower, comprises a convenient method for removing leaves, debris, and eliminating snow and ice on driveways, walkways, steps, and vehicles.

In a primary embodiment shown in FIG. 1, indicated at 10, Portable Blower consists of a molded plastic housing 12, containing an engine for propelling air of any suitable design, such as electric or gas two-stroke engine, as is well known in the art. Housing 12 additionally contains a heating element of any suitable design, such as electric resistance coil, ceramic element, or gas burner, as is well known in the art. Housing 12 features main switch 14. Actuating main switch 14 turns the power on and off. Housing 12 also features handle 18, by which the user conveniently carries and directs Portable Blower 10. Handle 18 features heat switch 16. Actuating heat switch 16 turns the heating element on and off. Housing 12 also features vent 22, allowing for air intake. Housing 12 also features heat control 26. At the rear of housing 12 is located power cord connection 24, allowing for power supply. The front of housing 12 features molded telescoping nozzle 28, allowing for air output.

When main switch 14 is turned to the on position, power supplied by power cord connection 24 activates the engine, causing air to be taken in through vent 22 and propelled through molded telescoping nozzle 28. The user directs the flow of air according to their needs by directing the nozzle toward the area to be blown by means of handle 18. When appropriate, actuating heat switch 16 to the “on” position directs power to the heating element, which heats the air taken in through vent 22 before it is propelled through molded telescoping nozzle 28. When heat switch 16 has been actuated, the user adjusts the temperature by turning heat control 26 to the desired level.

In an alternate embodiment shown in FIG. 2, and indicated at 30, a rechargeable Portable Blower is additionally equipped with rechargeable battery 54 and strap 52 for enhanced range and ease of portability. Portable Blower 30 additionally consists of rechargeable housing 32, containing an engine for propelling air of any suitable design, such as electric or gas two-stroke engine, as is well known in the art. Rechargeable housing 32 additionally contains a heating element of any suitable design, such as electric resistance coil, ceramic element, or gas burner, as is well known in the art. Rechargeable housing 32 features rechargeable main switch 34. Actuating rechargeable main switch 34 turns the power on and off. Rechargeable housing 32 also features rechargeable handle 38, by which the user conveniently carries and directs the rechargeable Portable Blower 30, as well as strap 52. Rechargeable handle 38 features rechargeable heat switch 36. Actuating rechargeable heat switch 36 turns the heating element on and off. Rechargeable housing 32 also features rechargeable vent 42, allowing for air intake. Rechargeable housing 32 also features rechargeable heat control 46. At the rear of rechargeable housing 32 is located rechargeable power cord connection 44 as well as rechargeable battery 54, both of which allow for power supply. The front of rechargeable housing 32 features rechargeable molded telescoping nozzle 48, allowing for air output and for directing the direction of air flow.

When rechargeable main switch 34 is turned to the “on” position, power supplied by either rechargeable power cord connection 44 or rechargeable battery 54 activates the engine, causing air to be taken in through rechargeable vent 42 and propelled through rechargeable molded telescoping nozzle 48. The user directs the flow of air according to their needs by directing the nozzle toward the area to be blown by means of rechargeable handle 38, while supporting the weight of the unit with strap 52 over their shoulder. When appropriate, actuating rechargeable heat switch 36 to the “on” position directs power to the heating element, which heats the air taken in through rechargeable vent 42 before it is propelled through rechargeable molded nozzle 48. When rechargeable heat switch 36 has been actuated, the user adjusts the temperature by turning rechargeable heat control 46 to the desired level.

By allowing for ambient temperature air output as well as heated air output, Portable Blower combines the functionality and convenience of a blower for removal of leaves and yard litter and other debris with the novel capability of melting away snow and ice from driveways, walkways, and personal vehicles. This eliminates the labor and strain of traditional snow- and ice-clearing methods, such as shoveling, scraping, and snow-blowing, and also eliminates the accumulation of shoveled snow by melting it away. Combined with the ability to melt snow and ice from vehicles, Portable Blower is an ideal alternative to traditional methods. The rechargeable capability enhances range of use for maximum convenience when clearing large spaces or extensive walkways and driveways.

The large-model Portable Blower is preferably gas-powered, while the small-model Rechargeable Blower is preferably electrically powered, either by a rechargeable battery-pack for use away from a power outlet. Or, through the use of an extension cord and standard household current

The Portable Blower of the present invention removes snow by evaporating the moisture, rather than simply moving it from one place to another. Users accustomed to snow-shoveling will love the lightweight convenience of this nearly labor-free device; and users accustomed to snow-throwers and snow-blowers will also find the Portable Blower or rechargeable blower a better alternative. Simply slip the sling-strap over the neck and shoulder, start the Blower (whether electric or gas-powered), and go, directing a focused, high-speed flow of heated air at the snow or ice on the driveway, the walks, the steps, the car windshield, and so on. The snow and ice will be converted into harmless melted water, and evaporated. No labor to speak of, no fuss: just that simple, just that quick. And because the Blower permits the user to operate the tool with or without heat, this tool is useful the year round: a leaf blower in the fall, a snow-remover in the winter.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable blower device for removing leaves, debris, and eliminating snow and ice on driveways, walkways, steps, and vehicles comprising:
a molded plastic housing having a front end and a rear end, wherein the housing contains:
an engine for propelling air;
a heating element;
a heat control;
a main switch;
a heat switch;
a handle;
telescoping nozzle at front end of housing;
vent at rear of housing; and
power cord connection at rear end of housing;
wherein main switch turns engine on or off; heat switch turns heating element on or off; heat control adjusts temperature; vent allows air intake; and telescoping nozzle allows air output.

2. The blower of claim 1 wherein the engine is an electric motor or gasoline two-stroke engine.

3. The blower of claim 1 wherein the heating element is electric resistance coil, ceramic element, or gas burner.

4. The blower of claim 1 wherein the heat switch is mounted onto the handle.

5. A method for removing leaves, debris, and eliminating snow and ice on driveways, walkways, steps, and vehicles comprising:
actuating main switch to the on position,
supplying power by power cord connection thereby activating the engine, causing air to be taken in through vent and propelled through molded telescoping nozzle;
directing the flow of air as needed by directing the nozzle toward the area to be blown by means of directing handle.

6. The method of claim 5 further comprising;
actuating heat switch to the “on” position supplying power to the heating element, adjusting the temperature by heat control, thereby heating the air taken in through vent before it is propelled through molded telescoping nozzle.

7. A rechargeable blower device for removing leaves, debris, and eliminating snow and ice on driveways, walkways, steps, and vehicles comprising:
a molded plastic housing having a front end and a rear end, wherein the housing contains:
an engine for propelling air;
a heating element;
a heat control;
a main switch;
a heat switch;
a handle;
telescoping nozzle at front end of housing;
vent at rear of housing;
rechargeable battery; and
strap, wherein main switch turns engine on or off; heat switch turns heating element on or off; heat control adjusts temperature; vent allows air intake; and telescoping nozzle allows air output.

8. The blower of claim 6 wherein the engine is an electric motor or gasoline two-stroke engine.

9. The blower of claim 6 wherein the heating element is electric resistance coil, ceramic element, or gas burner.

10. The blower of claim 6 wherein the heat switch is mounted onto the handle.
